(19) United States
(12) Patent Application Publication
(10) Pub. No.: US 2008/0258663 A1
(43) Pub. Date: Oct. 23, 2008

(54) Brushed motor controller using back EMF for motor speed sensing, overload detection and pump shutdown, for bilge and other suitable pumps

(76) Inventor: James Clay Walls, Trabuco Canyon, CA (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/148,528

(22) Filed: Apr. 18, 2008

Related U.S. Application Data
(60) Provisional application No. 60/925,359, filed on Apr. 18, 2007.

(51) Int. Cl. H02P 31/00

(52) U.S. Cl. 318/459

(57) ABSTRACT

A method and apparatus are provided for providing one or more brushed motor control signals for controlling the operation of a brushed motor, including a signal for disconnecting the power applied to the brushed motor so that the brushed motor can provide a brushed motor signal containing information about a collective back EMF from all poles of the brushed motor; and responding to the brushed motor signal, measuring the collective back EMF of the brushed motor, and providing the one or more brushed motor control signals for controlling the operation of the brushed motor.

### CROSS-REFERENCE TO RELATED APPLICATIONS

This application claims benefit to provisional patent application Ser. No. 60/925,359, filed 18 Apr. 2007, which is hereby incorporated by reference in its entirety.

### BACKGROUND OF THE INVENTION

1. Field of Invention

The present invention relates to provides a motor controller; and more particularly relates to a brushed motor controller for a device, such as a bilge pump.

2. Brief Description of Related Art

Consistent with that set forth in Wikipedia Encyclopedia, and as a person skilled in the art would appreciate, it is known in the art that a counter-electromotive force (abbreviated counter emf, or CEMF) is the voltage, or electromotive force, that pushes against the current which induces it. CEMF is caused by a changing electromagnetic field. It is represented by Lenz's Law of electromagnetism. Back EMF is a voltage that occurs in electric motors where there is relative motion between the armature of the motor and the external magnetic field. Counter emf is a voltage developed in an inductor network by a pulsating current or an alternating current. The voltage's polarity is at every moment the reverse of the input voltage. In a generator using a rotating armature and, in the presence of a magnetic flux, the conductors cut the magnetic field lines as they rotate. The changing field strength produces a voltage in the coil; the motor is acting like a generator. (Faraday's law of induction.) This voltage opposes the original applied voltage; therefore, it is called “counter-electromotive force”. (by Lenz's law.) With a lower overall voltage across the armature, the current flowing into the motor coils is reduced.

Techniques for sensing or measuring back EMF of a motor for safety or for preventing overload are known in the art; however, all of these techniques relate to brushless motors, as well as the use of back EMF as an electronic brake for a DC brushless motor based on the application of different current error signals.

Other techniques are known in the art that use back EMF for motor speed measurement and control; however, such known techniques do not analyze the back EMF curve generated by the motor during “spin-down” or “coasting” as a means of detecting total mechanical drag on the rotor (“rotor drag characterization”) and motor overload protection, and do not make use of back EMF for rotor drag characterization, motor overload protection and pump shutdown.

### SUMMARY OF THE INVENTION

The present invention provides a new and unique method and apparatus that provide one or more brushed motor control signals for controlling the operation of a brushed motor, including a signal for disconnecting the power applied to the brushed motor so that the brushed motor can provide a brushed motor signal containing information about a collective back EMF from all poles of the brushed motor; and respond to the brushed motor signal, measuring the collective back EMF of the brushed motor, and providing the one or more brushed motor control signals for controlling the operation of the brushed motor.

According to some embodiments of the present invention, the apparatus may take the form of a brushed motor controller, featuring one or more modules configured for providing one or more brushed motor control signals for controlling the operation of a brushed motor, including a signal for disconnecting the power applied to the brushed motor so that the brushed motor can provide a brushed motor signal containing information about a collective back EMF from all poles of the brushed motor, and configured for responding to the brushed motor signal, measuring the collective back EMF of the brushed motor, and providing the one or more brushed motor control signals for controlling the operation of the brushed motor.

The one or more modules may also be configured for implementing the following additional functionality, including either disconnecting the power of brushed motor, or spinning down the brushed motor without external power applied, or measuring the collective back EMF of all the poles, or some combination thereof; for using the brushed motor signal for determining motor speed, characterizing rotor drag, protecting against motor overload, shutting down the motor, or some combination thereof; for combining electric-field sensing for fluid detection with the use of the back EMF for controlling the brushed motor; for adjusting the speed of the brushed motor, shutting down the brushed motor, or any other suitable control system response; for measuring the collective back EMF being produced by the brushed motor using high-speed electronic instrumentation; for using the collective back-EMF to provide a value that is relative to the speed of the brushed motor at that instant; for indexing and using the relative value to obtain an indication of absolute motor speed; cleaning up a collective back-EMF voltage measurement using common analog and digital filtering and signal processing techniques; or some combination thereof.

According to some embodiments of the present invention, the one or more modules may form part of a chip set for implementing the functionality of the brushed motor controller.

According to some embodiments of the present invention, the apparatus may also take the form of a device, such as a bilge pump, featuring a brushed motor, responsive to one or more brushed motor control signals, and providing a brushed motor signal containing information about a collective back EMF from all poles of the brushed motor; and a brushed motor control having one or more modules configured for providing the one or more brushed motor control signals for controlling the operation of the brushed motor, including a signal for disconnecting the power applied to the brushed motor so that the brushed motor can provide the brushed motor signal, and configured for responding to the brushed motor signal, measuring the collective back EMF of the brushed motor, and providing the one or more brushed motor control signals for controlling the operation of the brushed motor.

According to some embodiments of the present invention, the apparatus may also take the form of a computer-readable storage medium having computer-executable components encoded with instructions that, when executed by a computer, perform: providing one or more brushed motor control signals for controlling the operation of a brushed motor, including a signal for disconnecting the power applied to the brushed motor so that the brushed motor can provide a brushed motor signal containing information about a collective back EMF from all poles of the brushed motor; and responding to the brushed motor signal, measuring the collective back EMF of the brushed motor, and providing the one or more brushed motor control signals for controlling the operation of the brushed motor.

In operation, the brushed motor responds to the one or more brushed motor control signals for controlling the operation of the brushed motor, including the signal for disconnecting the power applied to the brushed motor so that the brushed motor can provide the brushed motor signal containing information containing the collective back EMF from all poles of the brushed motor; and the brushed motor controller responds to the brushed motor signal, for measuring the collective back EMF of the brushed motor, and for providing the brushed motor control signals.

According to some embodiments of the present invention, the disconnection and back EMF measurement circuit can be very inexpensively designed and manufactured due to the fact that the collective back EMF for a brushed motor is much more easily measured than that for a brushless motor. For the brushed motor the commutator is in contact with all poles at all time. In contrast, in brushless motors, this is not the case; instead the measurement involves measuring back EMF for individual poles, and of course, timing the phase of the rotation of each pole to obtain such a measurement. The inexpensive design and manufacture of your brushed motor control may result in a more inexpensively priced bilge pump in an otherwise competitive marine marketplace.

In effect, the present invention combines electric-field sensing for fluid detection with utilization of back EMF for motor speed determination, rotor drag characterization, motor overload protection and pump shutdown. Using back EMF for rotor drag characterization can offer more sophisticated levels of control. Using back EMF for motor overload protection can inexpensively add protection to designs, save costs of implementing this protection by other means such as by sensing electrical current or applying thermal protection devices to the motor, and bolster the robustness of designs by inexpensively adding another layer of protective control in addition to other existing means of protection.

### BRIEF DESCRIPTION OF THE DRAWING

FIG. 1a shows a brushed motor controller according to some embodiments of the present invention.

FIG. 1b shows a device having a brushed motor controller and a brushed motor that operates according to some embodiments of the present invention.

FIG. 2 is an actual screen shot of a graph showing back EMF generated by a PMBR DC electric motor as it spins down after electrical power has been removed. Relative to the following figure, the motor in this case is experiencing a lower level of mechanical drag on the rotor (it is able to spin more freely).

FIG. 3 is a second screen shot of a graph showing back EMF generated by the same PMBR DC electric motor of FIG. 2. Relative to the conditions supporting the preceding figure, the motor in this case is experiencing a higher level of mechanical drag on the rotor.

FIG. 4 is a screen shot of a graph showing the two screenshots of FIGS. 2 and 3 having been superimposed for comparison.

FIG. 5 is a screen shot of a graph showing back EMF captured while switching power to the motor using a low frequency PWM at 50% duty cycle, where motor drag has been reduced compared to FIG. 6.

FIG. 6 is a screen shot of a graph showing back EMF captured while switching power to the motor using a low frequency PWM at 50% duty cycle. For this screenshot, motor drag was elevated by placing a mechanical load on the rotor.

FIG. 7 is an actual screen shot of a graph showing the two screen shots of FIGS. 5 and 6 superimposed for comparison.

FIG. 8a and 8b show operational flowcharts according to some embodiments of the present invention.

### BEST MODE OF THE INVENTION

### The Brushed Motor Controller 10

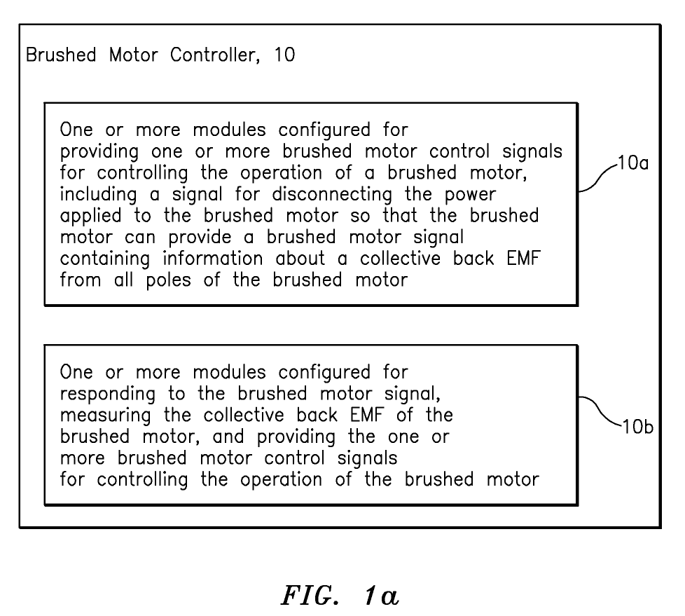

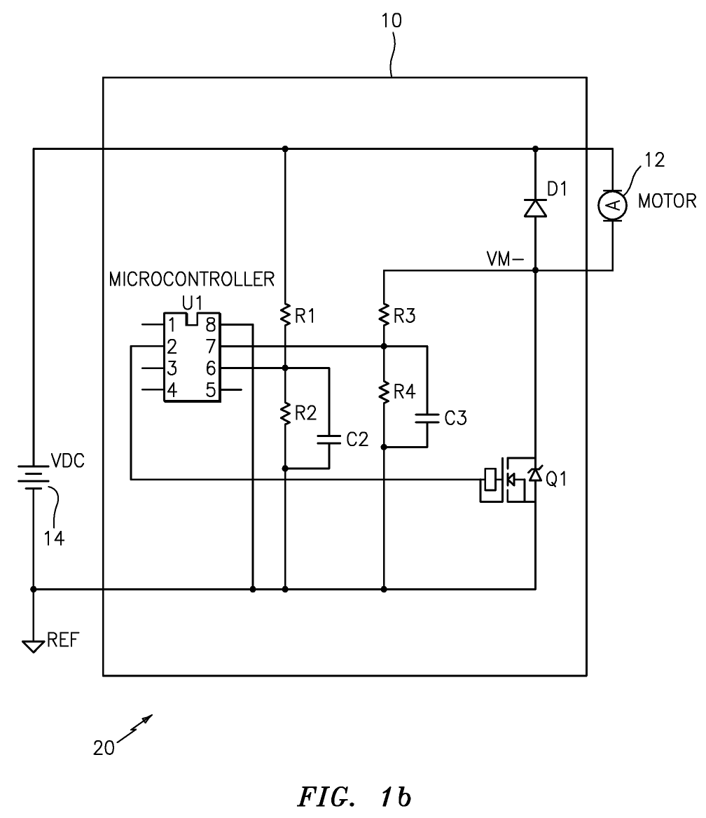

FIG. 1a shows a brushed motor controller 10, according to some embodiments of the present invention, featuring one or more modules 10a configured for providing one or more brushed motor control signals for controlling the operation of a brushed motor 12 (see FIG. 1b), including a signal for disconnecting the power applied to the brushed motor 12 so that the brushed motor 12 can provide a brushed motor signal containing information about a collective back EMF from all poles (not shown) of the brushed motor 12, and also configured for responding to the brushed motor signal, measuring the collective back EMF of the brushed motor 12, and providing the one or more brushed motor control signals for controlling the operation of the brushed motor 12. The controller 10 may also include one or more other modules that do not form part of the underlying invention, and are thus not shown or described herein.

### The Device 20

FIG. 1b is a simplified schematic of an example of a device 20 having the brush motor controller 10, the brushed motor 12 and a voltage source VDC 14. The brush motor controller 10 is shown in the form of an electronic circuit that can be used to implement the methods or techniques according to the present invention, including determining speed of the motor 12. The device 20 may take the form of a pump, e.g. a bilge pump, for a boat or other suitable marine vessel and have other components not shown or described herein since they do not form part of the underlying invention. Moreover, the scope of the invention is not intended to be limited to any particular type or kind of device that has a brushed motor in which the basic invention is implemented, and is intended to include other devices having brushed motors both now known or later developed in the future.

In FIG. 1b, the brushed motor controller 10 includes a microcontroller U1, a transistor Q1, resistors R1, R2, R3, R4, capacitors C2, C3 and diode D1, where:

VDC: A source of DC power, such as a battery or power supply.

MOTOR: A brushed DC motor, incorporating a wound rotating armature and stationary permanent magnets.

U1: A microprocessor or microcontroller, used to perform voltage measurements, make and execute decisions, and to control Q1 by means of control output Pin 2.

Q1: A high speed electronic switch, such as a MOSFET, used to switch motor power ON and OFF.

D1: A diode used to allow freewheeling current to flow from the motor during the observational OFF pulse.

R1 & R2: A resistive voltage divider network used to reduce the supply voltage to a level compatible with the analog input of the microcontroller U1 on Pin 6.

R3 & R4: A resistive voltage divider network used to reduce the motor voltage to a level compatible with the analog input of the microcontroller U1 on Pin 7. C2 and C3: Capacitors used to condition the voltage signals for the analog inputs of the microcontroller.

Using the circuit in FIG. 1b, the microcontroller U1 will apply power to the motor 12 by turning ON transistor Q1. The microcontroller U1 will turn OFF power to the motor 12 by turning OFF transistor Q1. When the microcontroller U1 turns OFF power to the motor 12, it will use an analog input on Pin 7 to measure node VM-. The microcontroller U1 can calculate a value for back EMF by subtracting the value measured on Pin 7 from the value of the supply voltage as measured on Pin 6.

The aforementioned technique for calculating or back EMF is described by way of example. However, the scope of the invention is not intended to be limited to any particular type or kind of technique for calculating or determining back EMF, and is intended to include other techniques for calculating or determining back EMF either now known or later developed in the future.

### The Concept of Back EMF

In order to facilitate an understand of the present invention, a simple description of the basic concept of back EMF is set forth, as a person skilled in the art would understand and appreciate it.

As shown, a typical motor, like a permanent-magnet brushed (PMBR) direct current (DC) electric motor, generates rotational force when a DC voltage is applied to windings (not shown) of its wound armature (not shown) via its brushes (not shown). Conversely, the physical rotation of the armature in a PMBR DC electric motor causes a voltage of fixed polarity to be generated by the windings as they cut lines of magnetic flux produced by the permanent magnets used in construction of the motor. In other words, the mechanical rotation of a PMBR DC electric motor causes it to behave as a DC electrical generator. Voltage that such a motor generates when mechanically rotated is referred to as “electro-motive force,” or EMF.

If the DC voltage of a given polarity is applied to the PMBR DC electric motor, the resulting rotational force produced within the motor will have a direction always consistent with that polarity. If the polarity of the applied DC voltage is reversed, then the direction of the rotational force produced by the motor will also reverse. Conversely, if the PMBR DC electric motor is mechanically rotated, the voltage it produces (EMF) will manifest in a polarity that opposes the polarity of an externally applied voltage necessary to cause rotation in that same direction. Because the polarity of the voltage produced by the rotating motor is in opposition to the applied voltage for that same direction of rotation, the term “back EMF” is used to refer to the voltage produced by the motor.

It is understood that the back EMF magnitude is proportional to the motor rotational speed. At zero speed, the motor produces zero back-EMF. As the motor spins and spins faster, the magnitude of back-EMF voltage increases proportionally. The relationship between rotational speed and back EMF is often linear over a wide speed range for practical motors.

Two voltages are at work simultaneously in the operating PMBR DC electric motor. The effective voltage seen by the windings of the armature is the difference between the externally applied voltage such as from a power supply or battery, and the internally generated back-EMF which is a function of motor speed. The back-EMF acts to subtract from the externally applied voltage, causing a reduction in the effective voltage across the armature windings. The faster the motor rotates, the greater is this subtractive effect, and vice-versa.

Under normal operating conditions, the back-EMF voltage is masked by the externally applied supply voltage and is not readily observable. However, if the externally applied supply voltage is removed quickly, such as by a high-speed switching device, then the back-EMF of the motor can be revealed and observed for a limited period of time.

This “window of observation” happens because of the inertia of a rotating motor and the mechanical load it is attached to. At speed, rotational inertia of the motor and any attached load cause the motor to continue to rotate for some finite amount of time after applied electrical power is removed. In practical systems, the motor exhibits some function of speed decay depending on the magnitude of the load inertia versus total drag on the rotor. For lightly-loaded systems, motor speed often exhibits a linear function of decay over time. As total rotor drag increases, such as by resistance from the load and/or condition of the bearings and other frictional loss sources, motor speed may decay according to exponential or other functions.

While the motor “spins down” without external power, it continues to generate a back-EMF voltage. With external power removed but the motor still rotating, suitably high-speed electronic instrumentation can be used to directly measure the back-EMF being produced by the motor. Measured this way, back-EMF provides a value that is relative to the speed of the motor at that instant. If need be, this relative value can be indexed and used for indications of absolute motor speed. The back-EMF voltage measurement can also be combined with common analog and digital filtering and signal processing techniques to “clean up” the signal in facilitation of practical ends.

In practical applications, the power switching device and observing electronic instrumentation can function so quickly that suitably accurate motor speed determination is possible without causing objectionable losses in motor speed. Once made, the measurement value can be used by a control system for any purpose, such as motor speed adjustment, shutdown, or any other conceivable or desired control system response.

Alternatively, if power is removed from the motor and maintained in that condition, the motor will “spin down” according to the sum of all conditions affecting the mechanical rotation of the motor and motor speed at the instant power was removed. In this case, decay of the back-EMF can be studied via instrumentation to characterize the mechanical resistance experienced by the rotor. This characteristic information can be used to make higher-order control decisions and inferences regarding system conditions.

In effect, the present invention uses this back EMF phenomenon to provide the new and unique methods and techniques described herein for determining motor speed using both pulsed (“snapshot”) and sustained (“spin-down”) measurements of back-EMF. Pulsed switching is used so as to control and/or preserve motor speed. The sustained observation, or spin-down method, is set forth for characterizing motor drag by measurement and analysis of the decay function of the back-EMF voltage during a sustained disconnection wherein the motor is allowed to spin down either partially or fully.

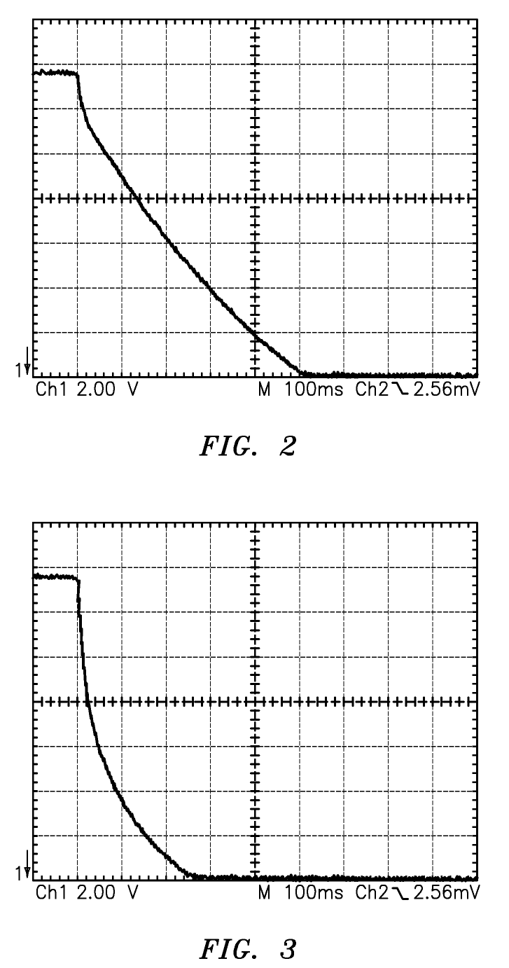

FIG. 2 is an actual screen shot of a graph showing back EMF generated by a PMBR DC electric motor as it spins down after electrical power has been removed. Relative to the following figure, the motor in this case is experiencing a lower level of mechanical drag on the rotor (it is able to spin more freely).

FIG. 3 is a second screen shot of a graph showing back EMF generated by the same PMBR DC electric motor of FIG. 2. Relative to the conditions supporting the preceding FIG. 2, the motor in this case is experiencing a higher level of mechanical drag on the rotor.

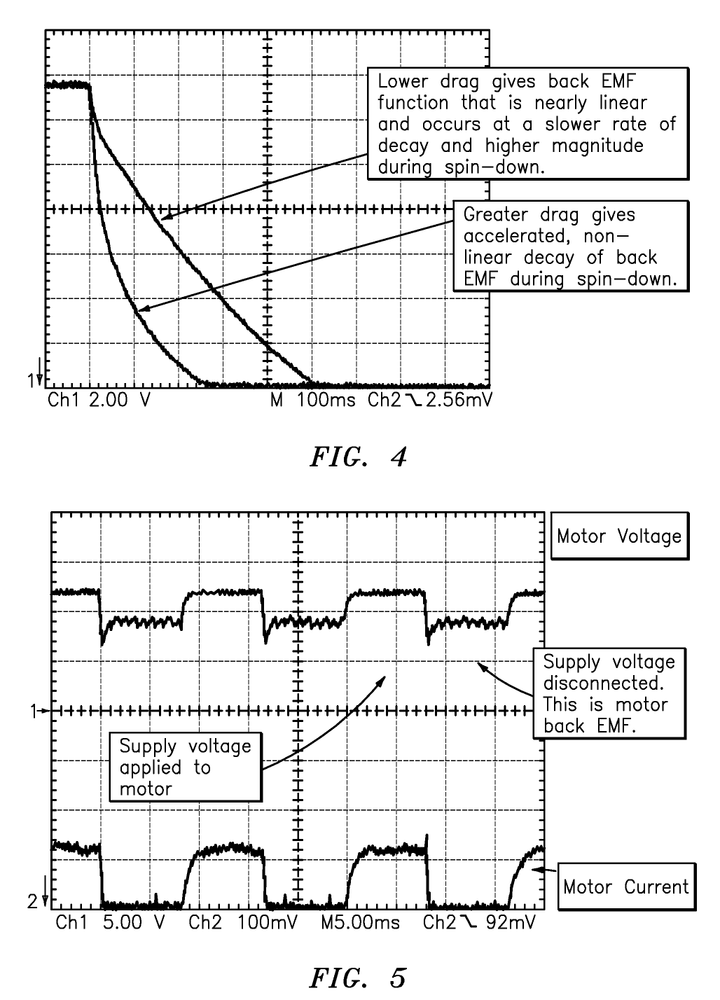

FIG. 4 is a screen shot of a graph showing the two screenshots of FIGS. 2 and 3 having been superimposed for comparison.

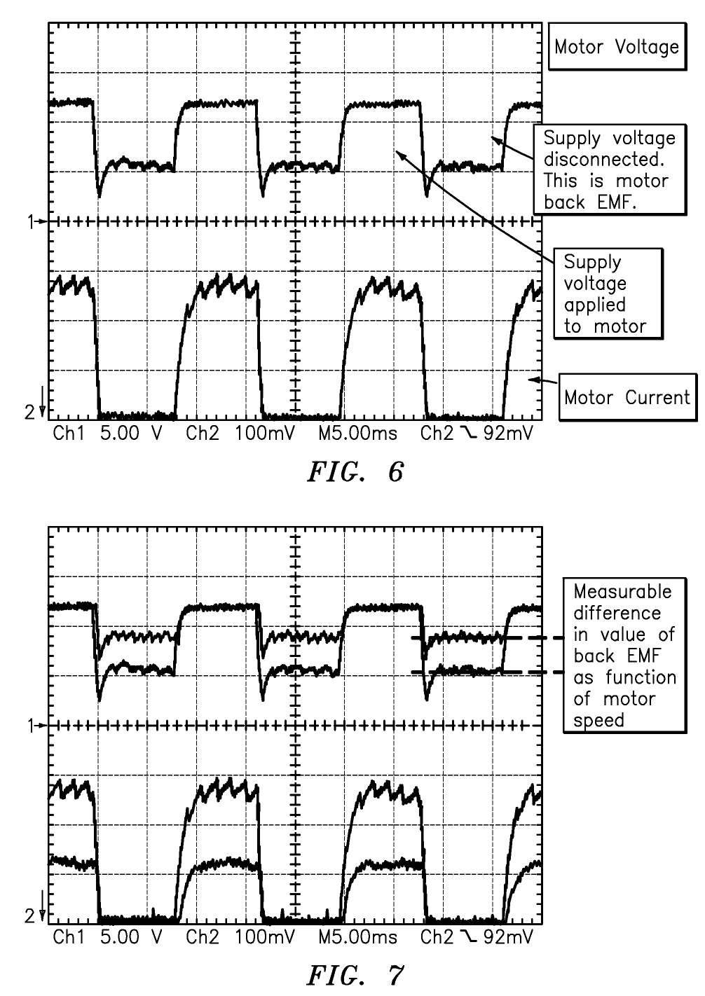

FIG. 5 is a screen shot of a graph showing back EMF captured while switching power to the motor using a low frequency PWM at 50% duty cycle, where motor drag has been reduced compared to FIG. 6.

FIG. 6 is a screen shot of a graph showing back EMF captured while switching power to the motor using a low frequency PWM at 50% duty cycle. For this screenshot, motor drag was elevated by placing a mechanical load on the rotor.

FIG. 7 is an actual screen shot of a graph showing the two screen shots of FIGS. 5 and 6 superimposed for comparison.

### Motor Speed Determination

In operation, the differences in amplitude of the back EMF can be measured, and the measured values then used to determine absolute or relative indications of motor speed. Repetitive observation pulses at a 50% duty cycle were used in the above examples. One obvious result of the 50% duty cycle is that the average voltage supplied to the motor will be cut in half. However, some application conditions require full supply voltage applied to the motor. A practical approach that allows for effectively full power operation is to make the observational OFF pulses short enough, and separated enough in time, that their impact is negligible or at least acceptable relative to system requirements. These have been coined the term “quasi-intermittent” to describe this implementation perspective.

For example, if an observational OFF pulse duration of 5 milliseconds (ms) is applied to the motor once every 50 ms, then the motor will see an effective reduction in applied voltage of 10%. Similarly, if the observation period is extended to 500 ms while holding the observational pulse duration fixed at 5 ms, then the effective reduction in applied voltage is only 1%. If the application requirements will tolerate sampling once a second, for example, then a 5 ms OFF pulse duration will reduce the effective voltage to the motor by only 0.5%, which may be imperceptible in the application. The occurrence of the interruption of motor power for the purpose of sampling the back EMF in this manner becomes infrequent and brief enough that it is essentially “quasi-intermittent” and tolerable within the requirements of performance of the total system.

Alternatively, the motor design voltage can be adjusted to allow high frequencies of motor speed sampling (where “high” is a relative term given meaning within a particular application). For example, suppose a given application requires a motor speed sampling frequency of 100 Hz. This means every 10 ms the motor speed should be determined. Suppose also that the supply voltage is 24 VDC. A solution can be considered by using a motor wound for 12V and an OFF sampling duration of 5 ms. The motor will see an average voltage of 12V, given by the equation, as follows:

AverageAppliedMotorVoltage=SystemVoltage*SamplingDutyRatio=24V* (5 ms/10 ms).

For a given design, the parameters can be adjusted by those skilled in the art to achieve an optimal solution.

The aforementioned technique for determining motor speed based on back EMF is described by way of example. However, the scope of the invention is not intended to be limited to any particular type or kind of technique for determining motor speed based on back EMF, and is intended to include other techniques for determining motor speed based on back EMF either now known or later developed in the future.

### Motor Overload Protection

Clearly, the foregoing addresses motor speed determination using the back EMF technique. With regards to motor overload protection, it is relevant to note that in a PMBR DC motor, if the supply voltage is fixed, then the slower the motor rotates the more electrical current the motor will draw. Motor overload refers to conditions where the electrical current drawn approaches the limits of magnetic saturation of the metals used in the motor construction, and also refers to conditions wherein the motor is prone to overheating as a result of drawing excessive electrical current. Conversely, in this context “excessive motor current” is defined as that which causes objectionable conditions in the motor.

If acceptability limits of motor current for a given motor and/or bilge pump design are established, then monitoring and analysis of back EMF can be used to provide a measure of overload protection for the motor. This is because back EMF reflects motor speed, which in turn reflects electrical current drawn by the motor, which in turn causes motor heating. This approach is advantageous over common methods wherein the electrical current is measured more directly, including current sense resistors (“current shunts”) and current sensors based on the Hall effect. The reason the back EMF method is advantageous is the lower part cost, since current sensing resistors and Hall effect current sensors cost more than the components required for back EMF sensing (see FIG. 1). In addition, low-Ohmic value current sensing resistors and current shunts generate heat, which in general is a disadvantage in electronic systems, whereas the back EMF method generates negligible heat.

Furthermore, heating in a given motor can be studied as a function of time together with motor current, so that a time and electrical stress limit model for the motor can be developed and implemented via an algorithm based in firmware in the microcontroller, again used to set and enforce overload protection for the motor.

Developing this concept further, temperature can be monitored by the microcontroller via a suitable sensor in a suitable and advantageous location, again to refine the degree of protection achievable using time and motor speed stress modeling while optimizing the design. For example, motor temperature rise can be characterized as a function of time and electrical stress, in which fluctuations in ambient temperature are monitored and added or subtracted from the value calculated by the model in order to better reflect the true temperature of the motor. This approach may have value over direct measurement of motor temperature as it is often costly or otherwise disadvantageous to place a temperature measurement device directly on the motor, but less costly or otherwise advantageous to place a temperature measurement device on the controlling circuit board in common bilge pump product designs.

The aforementioned technique for determining motor overload protection based on back EMF is described by way of example. However, the scope of the invention is not intended to be limited to any particular type or kind of technique for determining motor overload protection based on back EMF, and is intended to include other techniques for determining motor overload protection based on back EMF either now known or later developed in the future.

### Motor Shutoff Protection

With regards to motor shutdown other than because of motor overload protection, for example, a bilge pump control may need to have a means to shut down the motor if and when the water in the bilge has been acceptably removed by the pump. Conversely, the bilge pump control may need to maintain power to the motor as long as water remains to be pumped.

For example, if the bilge pump impeller is submerged, water pushed by the rotating impeller causes mechanical drag against the motor, which lowers motor speed and raises the electrical current drawn. If the bilge pump impeller is not submerged, the impeller spins faster and the motor draws less electrical current. This relationship is documented in U.S. Pat. No. 6,390,780, Batchelder, et al. and No. 5,549,456, Burrill, et al., which are hereby incorporated by reference in their entirety. Since the back EMF technique can be used to infer motor speed, it can be used to infer the submerged or non-submerged condition of the bilge pump impeller. Thus, by monitoring the back EMF, it is possible to infer if the impeller is submerged or not. If the back EMF is sufficiently high, where specific values are established by study and controlled by motor selection and production, then the bilge pump control has basis for deciding when to shut down the bilge pump.

The aforementioned technique for determining motor shutoff protection based on back EMF is described by way of example. However, the scope of the invention is not intended to be limited to any particular type or kind of technique for determining motor shutoff protection based on back EMF, and is intended to include other techniques for determining motor shutoff protection based on back EMF either now known or later developed in the future.

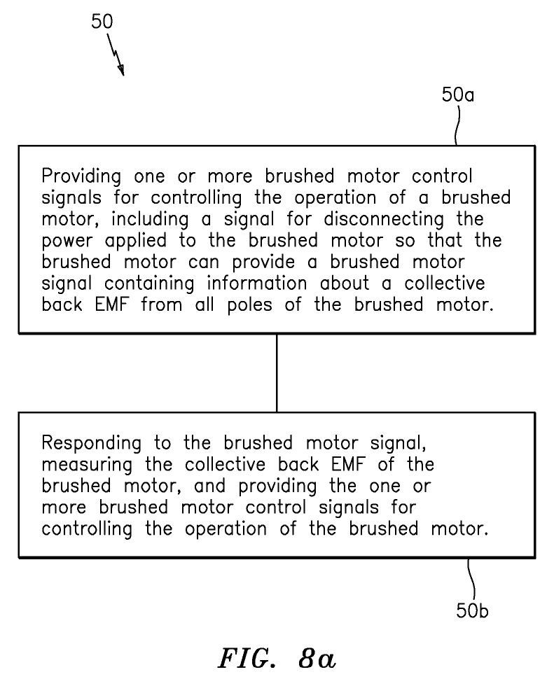

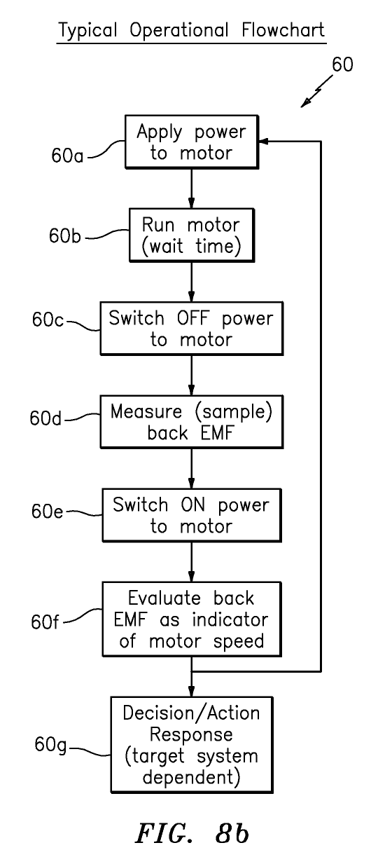

### FIGS. 8a and 8b Typical Operational Flowchart

FIGS. 8a and 8b shows, by way of example, operational flowcharts of methods for implementing some embodiments according to the present invention.

For example, FIG. 8a shows a flowchart 50 of one method having a step 50a for providing one or more brushed motor control signals for controlling the operation of a brushed motor, including a signal for disconnecting the power applied to the brushed motor so that the brushed motor can provide a brushed motor signal containing information about a collective back EMF from all poles of the brushed motor; and a step 50b for responding to the brushed motor signal, measuring the collective back EMF of the brushed motor, and providing the one or more brushed motor control signals for controlling the operation of the brushed motor.

FIG. 8b shows a flowchart 60 of another method having step 60a-60g for implementing an embodiment according to the present invention. As shown, in step 60a power is applied to the motor, such as motor 12 in FIG. 1b; in step 60b the motor is run; in step 60c the power to the motor is switched off; in step 60d the back EMF is measured; in step 60e the power to the motor is switched back on; in step 60f the measured back EMF is evaluated as an indicator of motor speed; and in step 60g a decision, action or response may be taken consistent with that described herein based on that evaluation.

### The Controller Module 10

In addition to the implementation shown by way of example in FIG. 1 b, the functionality of the one or more modules 10a, 10b that form part of the brushed motor controller 10 may be implemented using hardware, software, firmware, or a combination thereof. In a typical software implementation, the one or more modules that form part of the brushed motor controller would include one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology either now known or later developed in the future.

### The Chipset

In some embodiments according to the present invention, the one or more modules 10a, 10b may also form part of a basic chipset implementation that forms part of the overall brushed motor controller shown in FIG. 1a. The present invention may also take the form of the chipset that may include a number of integrated circuits designed to perform one or more related functions. For example, one chipset may provide the basic functions of the overall brushed motor controller, while another chipset may provide control processing unit (CPU) functions for a computer or processor in overall brushed motor controller. Newer chipsets generally include functions provided by two or more older chipsets. In some cases, older chipsets that required two or more physical chips can be replaced with a chipset on one chip. The term “chipset” is also intended to include the core functionality of a motherboard in such a brushed motor controller.

### The Brushed Motor 12

It is important to note that brushed motors, like element 12 above, are known in the art, and the scope of the invention is not intended to be limited to any particular type or kind either now known or later developed in the future.

By way of example, and consistent with that described in Wikipedia Encyclopedia, a brushless DC motor (BLDC) is typically understood by a person skilled in the art to be a synchronous electric motor which is powered by direct-current electricity (DC) and which has an electronically controlled commutation system, instead of a mechanical commutation system based on brushes. In such motors, current and torque, voltage and rpm are linearly related. A BLDC motor powering a micro remote-controlled airplane. The motor is connected to a microprocessor-controlled BLDC controller. This 5-gram motor produces more thrust than twice the weight of the entire plane. Being an outrunner, the rotor-can containing the magnets spins around the coil windings on the stator.

Two subtypes of brushed motors are typically known to exist: (1) The stepper motor type may have more poles on the stator, and (2) the reluctance type.

In a conventional (brushed) DC motor, the brushes make mechanical contact with a set of electrical contacts on the rotor (called the commutator), forming an electrical circuit between the DC electrical source and the armature coil-windings. As the armature rotates on axis, the stationary brushes come into contact with different sections of the rotating commutator. The commutator and brush system form a set of electrical switches, each firing in sequence, such that electrical-power always flows through the armature coil closest to the stationary stator (permanent magnet).

In a BLDC motor, the electromagnets do not move; instead, the permanent magnets rotate and the armature remains static. This gets around the problem of how to transfer current to a moving armature. In order to do this, the brush-system/commutator assembly is replaced by an electronic controller. The controller performs the same power distribution found in a brushed DC motor, but using a solid-state circuit rather than a commutator/brush system.

### List Possible Applications:

The invention can be applied to the control of:

a) All applications using permanent-magnet brushed DC electric motors.

b) Bilge pumps driven by permanent-magnet brushed DC electric motors.

### THE SCOPE OF THE INVENTION

It should be understood that, unless stated otherwise herein, any of the features, characteristics, alternatives or modifications described regarding a particular embodiment herein may also be applied, used, or incorporated with any other embodiment described herein. Also, the drawings herein are not drawn to scale.

Although the invention has been described and illustrated with respect to exemplary embodiments thereof, the foregoing and various other additions and omissions-may be made therein and thereto without departing from the spirit and scope of the present invention.

1. A method comprising:
providing one or more brushed motor control signals for controlling the operation of a brushed motor, including a signal for disconnecting the power applied to the brushed motor so that the brushed motor can provide a brushed motor signal containing information about a collective back EMF from all poles of the brushed motor; and
responding to the brushed motor signal, measuring the collective back EMF of the brushed motor, and providing the one or more brushed motor control signals for controlling the operation of the brushed motor.

2. A method according to claim 1, wherein the method further comprises either disconnecting the power of brushed motor, or spinning down the brushed motor without external power applied, or measuring the collective back EMF of all the poles, or some combination thereof.

3. A method according to claim 1, wherein the method further comprises using the brushed motor signal for determining motor speed, characterizing rotor drag, protecting against motor overload, shutting down the motor, or some combination thereof.

4. A method according to claim 1, wherein the method further comprises combining electric-field sensing for fluid detection with the use of the back EMF for controlling the brushed motor.

5. A method according to claim 1, wherein the method further comprises adjusting the speed of the brushed motor, shutting down the brushed motor, or any other suitable control system response.

6. A method according to claim 1, wherein the method further comprises measuring the collective back EMF being produced by the brushed motor using high-speed electronic instrumentation.

7. A method according to claim 1, wherein the method further comprises using the collective back-EMF to provide a value that is relative to the speed of the brushed motor at that instant.

8. A method according to claim 1, wherein the method further comprises indexing and using the relative value to obtain an indication of absolute motor speed.

9. A method according to claim 1, wherein the method further comprises cleaning up a collective back-EMF voltage measurement using common analog and digital filtering and signal processing techniques.

10. A brushed motor controller comprising:
one or more modules configured for providing one or more brushed motor control signals for controlling the operation of a brushed motor, including a signal for disconnecting the power applied to the brushed motor so that the brushed motor can provide a brushed motor signal containing information about a collective back EMF from all poles of the brushed motor, and configured for responding to the brushed motor signal, measuring the collective back EMF of the brushed motor, and providing the one or more brushed motor control signals for controlling the operation of the brushed motor.

11. A brushed motor controller according to claim 10, wherein the one or more modules are configured for either disconnecting the power of brushed motor, or spinning down the brushed motor without external power applied, or measuring the collective back EMF of all the poles, or some combination thereof.

12. A brushed motor controller according to claim 10, wherein the one or more modules are configured for using the brushed motor signal for determining motor speed, characterizing rotor drag, protecting against motor overload, shutting down the motor, or some combination thereof.

13. A brushed motor controller according to claim 10, wherein the one or more modules are configured for combining electric-field sensing for fluid detection with the use of the back EMF for controlling the brushed motor.

14. A brushed motor controller according to claim 10, wherein the one or more modules are configured for adjusting the speed of the brushed motor, shutting down the brushed motor, or any other suitable control system response.

15. A brushed motor controller according to claim 10, wherein the one or more modules are configured for measuring the collective back EMF being produced by the brushed motor using high-speed electronic instrumentation.

16. A brushed motor controller according to claim 10, wherein the one or more modules are configured for using the collective back-EMF to provide a value that is relative to the speed of the brushed motor at that instant.

17. A brushed motor controller according to claim 10, wherein the one or more modules are configured for indexing and using the relative value to obtain an indication of absolute motor speed.

18. A brushed motor controller according to claim 10, wherein the one or more modules are configured for cleaning up a collective back-EMF voltage measurement using common analog and digital filtering and signal processing techniques.

19. A brushed motor controller according to claim 10, wherein the one or more modules form part of a chip set for implementing the functionality of the brushed motor controller.

20. A device, including a bilge pump, comprising:
a brushed motor, responsive to one or more brushed motor control signals, and providing a brushed motor signal containing information about a collective back EMF from all poles of the brushed motor; and
a brushed motor control having one or more modules configured for providing the one or more brushed motor control signals for controlling the operation of the brushed motor, including a signal for disconnecting the power applied to the brushed motor so that the brushed motor can provide the brushed motor signal, and configured for responding to the brushed motor signal, measuring the collective back EMF of the brushed motor, and providing the one or more brushed motor control signals for controlling the operation of the brushed motor.

21. A device according to claim 20, wherein the one or more modules are configured for either disconnecting the power of brushed motor, or spinning down the brushed motor without external power applied, or measuring the collective back EMF of all the poles, or some combination thereof.

22. A device according to claim 20, wherein the one or more modules are configured for using the brushed motor signal for determining motor speed, characterizing rotor drag, protecting against motor overload, shutting down the motor, or some combination thereof.

23. A device according to claim 20, wherein the one or more modules are configured for combining electric-field sensing for fluid detection with the use of the back EMF for controlling the brushed motor.

24. A device according to claim 20, wherein the one or more modules are configured for adjusting the speed of the brushed motor, shutting down the brushed motor, or any other suitable control system response.

25. A device according to claim 20, wherein the one or more modules are configured for measuring the collective back EMF being produced by the brushed motor using high-speed electronic instrumentation.

26. A device according to claim 20, wherein the one or more modules are configured for using the collective back-EMF to provide a value that is relative to the speed of the brushed motor at that instant.

27. A device according to claim 20, wherein the one or more modules are configured for indexing and using the relative value to obtain an indication of absolute motor speed.

28. A device according to claim 20, wherein the one or more modules are configured for cleaning up a collective back-EMF voltage measurement using common analog and digital filtering and signal processing techniques.

29. A device according to claim 20, wherein the one or more modules form part of a chip set for implementing the functionality of the brushed motor controller.

30. A device according to claim 20, wherein the bilge pump is a high-speed switching bilge pump to remove externally applied voltage to the motor for a limited period of time.

31. A computer-readable storage medium having computer-executable components encoded with instructions that, when executed by a computer, perform: providing one or more brushed motor control signals for controlling the operation of a brushed motor, including a signal for disconnecting the power applied to the brushed motor so that the brushed motor can provide a brushed motor signal containing information about a collective back EMF from all poles of the brushed motor; and responding to the brushed motor signal, measuring the collective back EMF of the brushed motor, and providing the one or more brushed motor control signals for controlling the operation of the brushed motor.

32. Apparatus comprising:
means for providing one or more brushed motor control signals for controlling the operation of a brushed motor, including a signal for disconnecting the power applied to the brushed motor so that the brushed motor can provide a brushed motor signal containing information about a collective back EMF from all poles of the brushed motor; and
means for responding to the brushed motor signal, measuring the collective back EMF of the brushed motor, and providing the one or more brushed motor control signals for controlling the operation of the brushed motor.

33. Apparatus according to claim 32, wherein the apparatus further comprises means for disconnecting the power of brushed motor, or spinning down the brushed motor without external power applied, or measuring the collective back EMF of all the poles, or some combination thereof.
